(19) United States
(12) Patent Application Publication
(10) Pub. No.: US 2021/0251226 A1
(43) Pub. Date: Aug. 19, 2021

(54) METHOD AND COMPOSITION FOR INHIBITING THE GROWTH OF PSEUDOMONAS SYRINGAE ON A PLANT MATERIAL, AND KIT FOR TREATING THE SAME

(71) Applicant: City University of Hong Kong, Kowloon (HK)

(72) Inventors: Xin Deng, Kowloon (HK); Xiaolong Shao, Ngau Chi Wan (HK); Tingting Wang, Sha Tin (HK); Yingpeng Xie, Mong Kok (HK)

(21) Appl. No.: 16/792,400

(22) Filed: Feb. 17, 2020

(51) Int. Cl. A01N 37/02

(52) U.S. Cl. CPC A01N 37/02

(57) ABSTRACT

A method of inhibiting the growth of Pseudomonas syringae on a plant material, the method including applying, to the plant material, with a composition including an effective amount of one or more acetates. A composition for inhibiting the growth of Pseudomonas syringae on a plant material includes an effective amount of one or more acetates selected from the group consisting of sodium acetate, iron acetate, potassium acetate, lithium acetate, magnesium acetate, calcium acetate, aluminum acetate, and nickel acetate. A kit for treating an infection caused by Pseudomonas syringae on a plant material, the kit including one or more acetates.

### TECHNICAL FIELD

The invention relates to a method of inhibiting the growth of Pseudomonas syringae and particularly, although not exclusively, the growth of Pseudomonas syringae on a plant material.

### BACKGROUND

Pseudomonas syringae (P. syringae) is one of the most common plant bacterial pathogens, which causes economically significant diseases worldwide. The pathogenicity of P. syringae relies on type III secretion system (T3SS) that is encoded by a cluster of hrp genes.

Recently, researchers are attracted to developing methods treating or controlling the growth of P. syringae, including utilizing various bactericide compounds, biocontrol bacteria, and developing resistant plants. The two conventional anti-P. syringae agents are copper salts and streptomycin, both of which may be toxic to the plant and P. syringae was found to acquire resistance against these agents.

Accordingly, there is still a need to develop a method of suppressing bacterial virulence, especially one in a plant, without damaging the plant itself.

### SUMMARY OF THE INVENTION

It is an object of the invention to address the above needs, to overcome or substantially ameliorate the above disadvantages or, more generally, to provide a method of inhibiting the growth of P. syringae on a plant material.

In accordance with a first aspect of the invention, there is provided a method of inhibiting the growth of P. syringae on a plant material, the method comprising applying, to the plant material, with a composition comprising an effective amount of one or more acetates.

In accordance with a second aspect of the invention, there is provided a composition for inhibiting the growth of P. syringae on a plant material, comprising an effective amount of one or more acetates.

In accordance with a third aspect of the invention, there is provided a kit for treating an infection caused by P. syringae on a plant material, the kit comprising a solution comprising one or more acetates.

### BRIEF DESCRIPTION OF THE DRAWINGS

Embodiments of the invention will now be described, by way of example, with reference to the accompanying drawings in which:

FIG. 1 is an image showing the inhibitory effect of sodium acetate on a tomato leaf;

FIG. 2 is an image showing the inhibitory effect of sodium acetate on a bean leaf;

FIG. 3 is a graph comparing the inhibitory effects of different concentrations of sodium acetate on a tomato leaf;

FIG. 4 is a graph comparing the inhibitory effects of different acetate salts;

FIG. 5 is an image showing the inhibitory effects of iron acetate and optimized sodium acetate on a bean leaf;

FIG. 6 is an image showing the non-toxicity of the optimized acetate salt to P. syringae; and

FIG. 7 is an image showing the non-toxicity of the optimized acetate salt to a bean leaf.

### DETAILED DESCRIPTION OF THE PREFERRED EMBODIMENT

Unless otherwise defined, all technical terms used herein have the same meaning as commonly understood by one skilled in the art to which the invention belongs.

As used herein, “comprising” means including the following elements but not excluding others. “Essentially consisting of” means that the material consists of the respective element along with usually and unavoidable impurities such as side products and components usually resulting from the respective preparation or method for obtaining the material such as traces of further components or solvents. “Consisting of” means that the material solely consists of, i.e. is formed by the respective element. Other than in the working examples, or where otherwise indicated, all numbers used herein should be understood as modified in all instances by the term “about”. The term “about” when used in connection with a number can mean, for example, ±2%.

The present invention pertains to a method of inhibiting the growth of P. syringae on a plant material, the method comprising applying, to the plant material, with a composition comprising an effective amount of one or more acetates. The term “plant material” as used herein refers to any plant parts from any plant species, for example, grasses, rushes, barks, woods, stems, roots, seeds, and leaves. The method may be applied to any plant materials in any environments, such as humid, dry, low-temperature, and high-temperature environments. The plant material includes any species and any part of a plant. In an embodiment, the plant material is a tomato plant or a bean plant, or a part of a tomato plant or a bean plant, for example the leaves of the plants.

The composition of the present invention comprises one or more acetates selected from the group consisting of sodium acetate, iron acetate, potassium acetate, lithium acetate, magnesium acetate, calcium acetate, aluminum acetate, and nickel acetate. Particularly, the composition may comprise at least one of sodium acetate, iron acetate, and nickel acetate. Preferably, the composition comprises sodium acetate which is highly dissolvable in water and has promising effect on inhibiting the growth of P. syringae. In another embodiment, the composition comprises an effective amount of sodium acetate and iron acetate. Sodium acetate and iron acetate together substantially reduce the pathogenic P. syringae on a plant material thereby promoting the growth of the plant material.

The expression “effective amount” and “effective dose” generally denote an amount sufficient to have a beneficial effect or to achieve desirable results, wherein the exact nature of the result may vary depending on the specific subject, i.e. the plant material. The effective amount of the composition of the present invention may depend on the species, plant part, area, age and individual conditions of the plant material and can be determined by standard procedures such as with experimental plants. In an embodiment herein, the effective amount of the composition is capable of inhibiting the growth of P. syringae on a plant material by about 50% or above, about 70% or above, or about 95% or above compared to an infected plant material. In a particular embodiment, the colony number of P. syringae treated with the composition herein is determined and the effective amount of the one or more acetates is capable of reducing the colony number by about 50% or above, about 70% or above, or about 95% or above. A concentration of the composition may, for example, be at least about 0.1 mM.

The effective amount of each of the one or more acetates for inhibiting the growth of P. syringae is from about 0.01 mM to about 200 mM, preferably from about 0.1 mM to about 100 mM. In an embodiment, the composition contains from about 0.1 mM to about 100 mM, about 1 mM, about 10 mM or about 100 mM of sodium acetate. In another example embodiment, the composition contains from about 0.1 mM to about 10 mM particularly 1 mM of sodium acetate, and from about 0.01 mM to about 1 mM particularly 0.1 mM of iron acetate.

The composition can be present in solid, semisolid or liquid form. The composition can be applied in the form of a powder or a solution. The composition can be prepared in the form of an aerosol containing fine solid particles or liquid droplets of the one or more acetates. The composition of the present invention can be applied via injection, in particular via a syringe, or topical application such as via a spraying method, or by allowing the composition to “sit on” the plant material (e.g. when it is in the powder form).

Turning back to the method, the method comprises the step of applying, to the plant material, with the composition as described above. In an embodiment where the composition is provided in the form of a powder or an aerosol containing solid particles of the one or more acetates, the composition may be directly placed on the infected area of the plant material or may be sprayed on the plant material.

In another embodiment where the composition is provided in the form of a solution or an aerosol containing liquid droplets, the composition may be sprayed onto the plant material or injected into the infected part of the plant material using a syringe. For example, the composition may be injected into the leaf vein of an infected leaf. Alternatively, the composition may be applied by mixing the composition with other nutrient solutions or agents so as to be provided to the plant material simultaneously. In a preferred embodiment, the one or more acetates in the composition is water-soluble, such as sodium acetate, iron acetate, and nickel acetate, such that the composition may be provided in the form of a solution for easy application to the plant material. It is also possible to apply the liquid composition by soaking a part of or the whole plant material in to the liquid composition for a period of time.

The inventors have, through their own research, trials and experiments, devised that sodium acetate is capable of inhibiting pathogenic P. syringae virulence in host plant. There are currently two major anti-P. syringae agents in the market, i.e. copper salts and streptomycin, but they may not be the ideal drugs for treating P. syringae infection in terms of cost, availability, efficiency, etc. When compared to copper salts and streptomycin, sodium acetate offers a low price, excellent efficiency (removing infection symptom at 10 mM vs minimum inhibitory concentration (MIC) of 3 mM for copper sulfate and MIC of 1 mg/mL of streptomycin), and shows no toxicity or resistance on plant (present for both copper salt and streptomycin), showing a great potential and value in the agricultural market. The inventors further optimized the composition containing sodium acetate by adding iron acetate. The optimized composition also has a better anti-P. syringae infection capability when compared to the two conventional agents.

In a further aspect, the present invention provides a composition as described above for inhibiting the growth of Pseudomonas syringae on a plant material, comprising an effective amount of one or more acetates. The composition particularly contains sodium acetate, nickel acetate and/or iron acetate. It would be appreciated that the composition may be used in conjunction with other agents to promote or improve the growth of the plant material. The agents may include, but may not be limited to, chemicals that provide nutrients to the plant material, stimulate the growth of the plant material, and/or inhibit other pathogenic bacteria.

Alternatively, additional agents that can be used together with the composition also include, but not limited to, copper salts and an antibiotic such as streptomycin.

In a further aspect, the present invention provides a kit for treating an infection caused by P. syringae on a plant material. The term “treating an infection” as used herein refers to amelioration, prevention or relief from the symptoms and/or effects associated with the infection. For example, after treatment, the infected area of the plant material which shows water-soaked patches or necrotic dots can be recovered.

The kit contains the one or more acetates as described above, particularly the one or more acetates are selected from the group consisting of sodium acetate, iron acetate, potassium acetate, lithium acetate, magnesium acetate, calcium acetate, aluminum acetate, and nickel acetate, and an instruction manual listing appropriate steps for preparing and applying the composition which is as described above. In an embodiment, the kit includes solid particles of one or more acetates which can be dissolved in a liquid such as water via stirring and mixing before application to the plant material. Alternatively, the kit includes a solution comprising the one or more acetates, and optionally a syringe for injection or a spray for topical application. The solution may have the composition described as described above.

The examples set out below further illustrate the present invention. The preferred embodiments described above as well as examples given below represent preferred or exemplary embodiments and a skilled person will understand that the reference to those embodiments or examples is not intended to be limiting.

### Inhibitory Effect of Sodium Acetate

To study the inhibitory effect of sodium acetate (denoted as NaAc) on a host plant, 2×10⁴ CFU/ml of wild-type P. syringae, with 10 mM NaAc, was injected via a syringe using an inoculation method, and infiltrated into the primary leaves of 3-week-old tomato and bean plants.

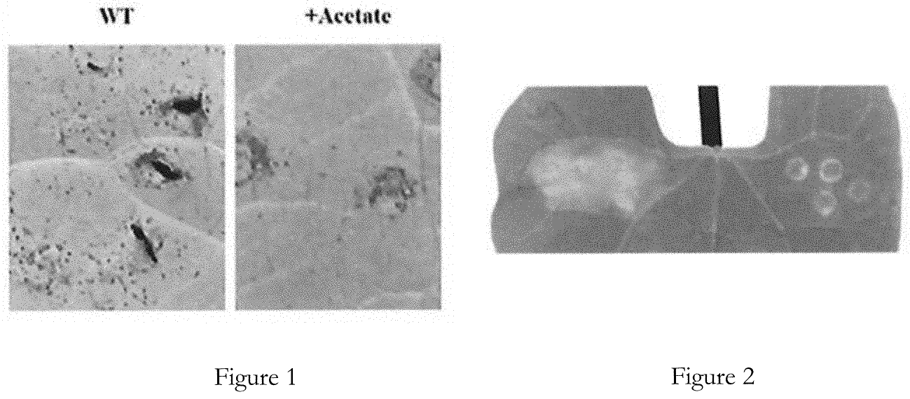

FIGS. 1 and 2 show the inhibitory effect of sodium acetate on a tomato leaf and a bean leaf, respectively. Disease symptoms elicited by P. syringae on the plant leaves are displayed as dots on the leaves. It is demonstrated that spray of 10 mM NaAc solution significantly reduced bacterial pathogenicity on both the tomato leaf and bean leaf after 6 days of inoculation. It should be noted that the wilted regions in the figures are not disease symptoms, but rather result from injection via syringe during inoculation.

To study the effect of concentration of NaAc on inhibiting growth of P. syringae, 2×10⁴ CFU/ml of wild-type P. syringae pv. tomato bacteria were injected into the tomato leaves. Then, the inoculated leaves were sprayed with water and 0.1-100 mM NaAc. Three 1 cm² leaf disks at 6 day post inoculation were homogenated and diluted in water to count bacterial CFUs. The results were repeated three times.

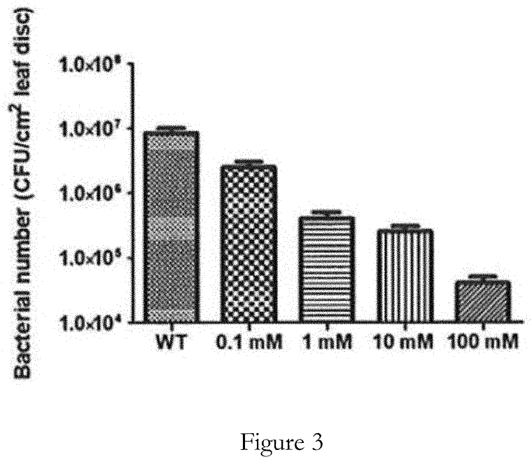

FIG. 3 shows the comparison of the inhibitory effects of different concentrations of sodium acetate on a tomato leaf. The differences between the water control and NaAc spray at 6 day post inoculation are significant with P<0.05. It has been determined that of concentrations from 0.1 mM to 100 mM, the best concentration of NaAc for reducing bacterial growth of syringe-inoculated P. syringae pv. tomato on tomato is 100 mM.

### Optimization of Sodium Acetate

To study the inhibitory effect of different acetate salts to inhibit P. syringae, 1 mM of 12 acetate salts was tested on the expression of hrpL, namely on hrpL-lux activities, in the wild-type P. syringae. The 12 acetate salts included acetate salts of lithium (Li), potassium (K), magnesium (Mg), sodium (Na), calcium (Ca), manganese (Mn), aluminium (Al), nickel (Ni), acetic acid (denoted as HAc), copper (Cu), ammonium (NH₄), and iron (Fe).

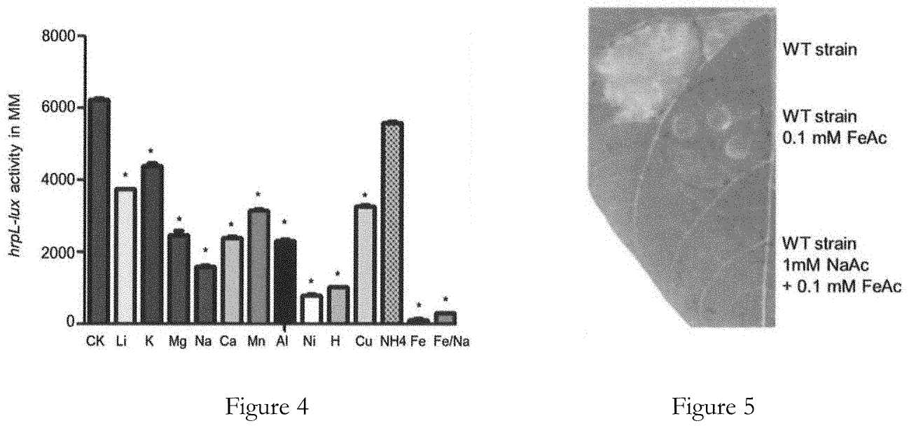

As shown in FIG. 4, out of the 12 acetate salts tested, it was found that iron acetate (denoted as FeAc) presented the best inhibitory effect, followed by NiAc₂, HAc, and NaAc. The asterisks denote statistical significance with P<0.05 from the wild-type without supplement.

To find the optimized acetate salt for inhibiting growth of P. syringae, the inventors further tested the effect of 1 mM NaAc supplemented with 0.1 mM FeAc on hrpL-lux activities in the wild-type P. syringae.

FIG. 4 demonstrates that when compared to 1 mM NaAc alone, 1 mM NaAc supplemented with 0.1 mM FeAc generated better inhibitory effect. It was therefore determined that this combination is the optimized NaAc recipe for inhibiting growth of P. syringae.

To study the inhibitory effect of the optimized NaAc recipe, 0.1 mM FeAc and 1 mM NaAc supplemented with 0.1 mM FeAc and 2×10⁴ CFU/ml of wild-type P. syringae pv. tomato bacteria were injected into the bean leaves.

FIG. 5 shows that the optimized NaAc recipe significantly reduced the virulence of the wild-type strain to the tested host plant, i.e. the bean leaf, when compared to 0.1 mM FeAc.

### Non-Toxicity of Optimized Sodium Acetate

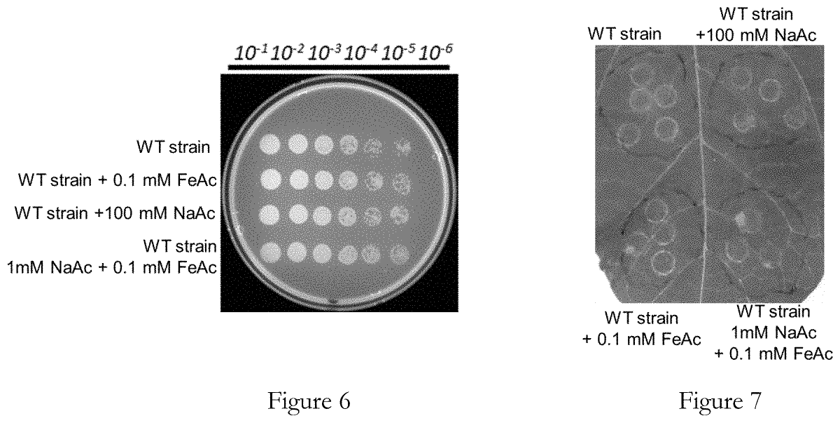

To study whether the optimized NaAc recipe is toxic to P. syringae, a P. syringae liquid culture was treated with 0.1 mM FeAc, 100 mM NaAc, and the optimized recipe (1 mM NaAc and 0.1 mM FeAc) respectively for 2 hours. The treated and control (untreated) cultures were then diluted for counting bacterial CFUs. FIG. 6 shows the results of the experiment, illustrating the non-toxicity of the optimized NaAc recipe to P. syringae.

Furthermore, to study whether the optimized NaAc recipe is toxic to a host plant, aqueous solutions of 0.1 mM FeAc, 100 mM NaAc, and the optimized recipe (1 mM NaAc and 0.1 mM FeAc) were respectively injected into tomato and bean leaves and inoculated for 6 days. FIG. 7 shows the results on a bean leaf as the host plant, demonstrating the non-toxicity of the optimized NaAc recipe to the bean leaf.

Accordingly, the present invention provides a novel and reliable method of inhibiting the growth of P. syringae on a plant material, both in greenhouse and field trial. The acetate salt involved, more particularly sodium acetate, is highly active in repressing T3SS and inducing RhpRS, thereby suppressing bacterial virulence in the plant material.

The present invention is advantageous in that sodium acetate is not toxic to both P. syringae and the plant to which it is applied, and not resistant to P. syringae on the plant, in contrast with conventional copper salts and streptomycin. The use of sodium acetate thus provides an economical, efficient and safe anti-P. syringae agent for treating P. syringae on a plant.

It will be appreciated by persons skilled in the art that numerous variations and/or modifications may be made to the invention as shown in the specific embodiments without departing from the scope of the invention as broadly described. The described embodiments of the invention should therefore be considered in all respects as illustrative, not restrictive. Any reference to prior art contained herein is not to be taken as an admission that the information is common general knowledge, unless otherwise indicated.

1. A method of inhibiting the growth of Pseudomonas syringae on a plant material, the method comprising applying, to the plant material, with a composition comprising an effective amount of one or more acetates.

2. The method according to claim 1, wherein the effective amount of each of the one or more acetates is from about 0.01 mM to about 200 mM.

3. The method according to claim 2, wherein the effective amount of each of the one or more acetates is from about 0.1 mM to about 100 mM.

4. The method according to claim 1, wherein the composition is provided in the form of a powder or a solution.

5. The method according to claim 1, wherein the composition is applied to the plant material via injection or tropical application.

6. The method according to claim 1, wherein the composition comprises at least one of sodium acetate, iron acetate, and nickel acetate.

7. The method according to claim 1, wherein the composition comprises from about 0.1 mM to about 10 mM of sodium acetate, and from about 0.01 mM to about 1 mM of iron acetate.

8. The method according to claim 1, wherein the plant material is a tomato plant or a bean plant.

9. A composition for inhibiting the growth of Pseudomonas syringae on a plant material, comprising an effective amount of one or more acetates selected from the group consisting of sodium acetate, iron acetate, potassium acetate, lithium acetate, magnesium acetate, calcium acetate, aluminum acetate, and nickel acetate.

10. The composition according to claim 9, wherein the effective amount of each of the one or more acetates is from about 0.01 mM to about 200 mM.

11. The composition according to claim 9, wherein the effective amount of each of the one or more acetates is from about 0.1 mM to about 100 mM.

12. The composition according to claim 9, wherein the composition is provided in the form of a powder or a solution

13. The composition according to claim 9, wherein the composition comprises at least one of sodium acetate, iron acetate, and nickel acetate.

14. The composition according to claim 9, wherein the composition comprises sodium acetate and iron acetate.

15. The composition according to claim 9, wherein the composition comprises from about 0.1 mM to about 10 mM of sodium acetate, and from about 0.01 mM to about 1 mM of iron acetate.

16. The composition according to claim 9, wherein the composition comprises about 1 mM of sodium acetate and about 0.1 mM of iron acetate.

17. A kit for treating an infection caused by Pseudomonas syringae on a plant material, the kit comprising one or more acetates selected from the group consisting of sodium acetate, iron acetate, potassium acetate, lithium acetate, magnesium acetate, calcium acetate, aluminum acetate, and nickel acetate, and an instruction manual.

18. The kit according to claim 17, wherein the kit comprises at least one of sodium acetate, iron acetate, and nickel acetate.

19. The kit according to claim 17, wherein the kit comprises from about 0.1 mM to about 10 mM of sodium acetate, and from about 0.01 mM to about 1 mM of iron acetate in a composition.

20. The kit according to claim 17, wherein the plant material is a tomato plant or a bean plant.
